(19) United States
(12) Patent Application Publication
(10) Pub. No.: US 2015/0278958 A1
(43) Pub. Date: Oct. 1, 2015

(54) METHOD FOR TAKING AN INVENTORY OF A PATIENT'S PRESCRIPTIONS AND SELECTING A HEALTH INSURANCE PLAN

(71) Applicant: Meditory Corporation, Brighton, MI (US)

(72) Inventors: Alexander Brunner, Howell, MI (US); Malcolm Roy, Plano, TX (US)

(21) Appl. No.: 14/713,829

(22) Filed: May 15, 2015

Related U.S. Application Data
(63) Continuation-in-part of application No. 14/464,758, filed on Aug. 21, 2014.
Application No. 14/464,758 is a continuation of application No. 13/752,009, filed on Jan. 28, 2013, now Pat. No. 8,823,770.
(60) Provisional application No. 61/590,976, filed on Jan. 26, 2012.

(51) Int. Cl. G06Q 40/08; G06F 19/00; G06T 5/00

(52) U.S. Cl. CPC G06Q 40/08; G06T 5/002; G06F 19/322; G06F 19/3456; G06T 2207/10004

(57) ABSTRACT

A method for evaluating a number of prescription drug health care plans includes the steps of providing a device for scanning the label of each of a patient's prescription labels, and extracting the data from the labels into a digital format. The digitized prescription label data is then entered into a database including prescription drug health care plans and total out-of-pocket cost to the patient is calculated for each health care plan in the database based upon the costs associated with each plan in view of that particular patient's prescription drug needs.

### CROSS REFERENCE TO RELATED APPLICATION

This application is a continuation-in-part of pending U.S. application Ser. No. 14/464,758, filed Aug. 21, 2014, which is a continuation of U.S. application Ser. No. 13/752,009, filed Jan. 28, 2013, which claims the benefit of U.S. Provisional Application 61/590,976, which was filed on Jan. 26, 2012, the disclosures of each of these are hereby incorporated by reference.

### BACKGROUND OF THE INVENTION

1. Field of the Invention

The present invention pertains to a method for taking an inventory of a patient's prescription medicine and selecting a prescription drug health insurance plan. More particularly, the present invention pertains to a method for inventorying a patient's prescription drugs, generating a list of potential prescription drug health plans based upon the patient's particular prescription drug needs, and determining the total out-of-pocket costs to the patient for each health plan in the list, thereby making it easy for the patient to select a competitive prescription drug plan.

2. Description of the Prior Art

Selecting a prescription drug health insurance plan can be a very laborious task. The federal government of the United States provides a database of the prescription drug health insurance plans which allows a patient to enter their prescription drugs, the dosages, and other information. The database will produce a list of possible prescription drug health plans and provide information relating to the cost for each plan based upon that particular patient's needs.

However, this process is time-consuming and tedious, and it is also prone to data entry mistakes. The patient must enter correct dosages and any other relevant information or the results will be inaccurate. Also, many drugs have different varieties which are typically designated with a suffix at the end of the drug name, and the correct variety must be entered or the patient risks selecting a plan that does not even cover a drug that they must have. And even more so, the patient could forget to enter one of their prescription drugs altogether. In addition, the database provided by the United States government does not produce results in a clear and concise manner, and it is difficult to understand the true out-of-pocket cost to the patient.

Many of the patients who are eligible for a prescription health care plan are senior citizens. This important task of selecting a prescription drug health care plan is beyond many of their capabilities due to mental debilitation, memory problems, and/or an insufficient skill level with a computer.

Because of the reasons stated above, many patients use an independent agent to help them select a prescription drug health plan. These agents assume liability for entering each of the patient's prescription drugs and for entering all of the correct information to obtain accurate results. Failure to enter every prescription or entering one or more incorrectly could result in the patient not having insurance coverage for that drug for the year. This could result in potentially catastrophic cost to the patient, and ultimately the agent could be liable for this expense. For this reason, many independent agents carry insurance to protect them from this potential liability.

In addition, the agent must be prepared to look up the various drug plan information out of a hardbound copy of the government database when an Internet connection is not available. Many senior citizens do not have a wireless Internet network in their home, which is where the agent will often meet with the patient to help them select the plan. Accordingly, it is quite common for the agent to have to resort to flipping through the cumbersome government book. It can be quite unsettling for the patient to watch the agent work their way through this book, especially if they are not very proficient at it. This can give the patient great concern that they will not choose a good insurance plan even though they have sought professional help in doing so.

Thus, there needs to be a way of selecting a prescription drug health care plan which is faster, more reliable, and produces results in a clear and concise manner that the patient can use to easily select the best plan.

The present invention, as is detailed hereinbelow, seeks to fill this need by providing a method for automatically obtaining the information off of each of the patient's prescription labels, extracting the data into a digital format, entering the data into a database including prescription drug health care plans, and generating a sortable list of healthcare plans based upon out-of-pocket costs to the patient customized to that patient's prescription drug needs.

### SUMMARY OF THE INVENTION

A first embodiment of the invention pertains to a method of compiling and ranking health insurance plans for a patient including the steps of: (a) providing a scanning device for scanning at least one prescription container including medical information, the scanning device configured to obtain image data from the prescription container; (b) providing a computer having software that is configured to create digitized text from text characters in an image of the prescription container; (c) transmitting the image data from the scanning device to the computer; (d) creating a two-dimensional image of at least a portion of the prescription container using the image data; (e) creating digitized text, by the software, of the medical information on the two-dimensional image, the medical information including at least a drug name; (f) providing a database including a plurality of health insurance plans; (g) calculating a cost to the patient using the medical information and information contained in the database of health insurance plans; and (h) creating a list of at least two of the health insurance plans including the calculated cost to the patient for each of the listed health insurance plans, and the list being sortable by cost to the patient in order to rank the health insurance plans.

Optionally, this medical information includes at least one of the following from the group consisting of: a drug dosage, a dosage form, a prescription quantity, prescription notes, and a drug name suffix. The medical information can also include each of a drug dosage, a dosage form, a prescription quantity, prescription notes, and a drug name suffix.

Optionally, the step of creating digitized text can include the use of one or more optical character recognition operations. When multiple optical character recognition operations are used, it is also optional to further include the step of assigning a confidence level to portions of the digitized text based upon the consistency of the results from the plurality of optical character recognition operations.

Optionally, this method can also include the step of assigning a minimum threshold level for the assigned confidence levels, and further including the step of manually verifying, by a user, that the digitized text was correctly generated from the image data for the portions of the digitized text in which the confidence level is below the minimum threshold level.

A second embodiment of the invention pertains to a method of generating a photographic inventory of a patient's prescription containers comprising the steps of: (a) providing a scanning device for scanning at least one prescription container including medical information, the scanning device configured to obtain image data from the prescription container, and the scanning device including: (i) a housing having a receptacle for receiving the prescription container, the receptacle having a floor and an interior sidewall, the interior sidewall including a plurality of lights for illuminating the prescription container; (ii) a rotatable turntable positioned on the floor of the receptacle and the prescription container being positionable on the turntable; and (iii) at least one camera located within the housing and positioned so that the camera can obtain images of the prescription container, the camera being configured to obtain still images of various angles of the prescription container as the prescription container is rotated on the turntable; (b) providing a computer having software that provides for entry of a name of an operator; (c) transmitting the image data from the scanning device to the computer; (d) providing a database and storing the information in the database that is accessible by the computer, the database including the following information associated with each prescription container: a two-dimensional image of each prescription container that is generated using the image data, the name of the operator, and the name of the patient.

Optionally this method can include the step of manually entering the name of the operator by typing the name into the computer. This method can also optionally include the step of manually entering the name of the patient by typing the patient's name into the computer.

Optionally this method can also include the step of performing optical character recognition, by the software, on the two-dimensional image of each of the prescription containers.

This can further include the step of performing the optical character recognition to generate digitized text, and the digitized text includes any of the following from the group of medical information: a drug name; a drug dosage; a dosage form; a prescription quantity; prescription notes; and a drug name suffix.

Optionally this method includes in which the software performs at least two optical character recognition operations, and each optical character recognition operation utilizes a unique set of parameters for determining each character of the digitized text.

Optionally this method can include the step of assigning a confidence level to portions of the digitized text, the confidence level being determined by the consistency or variation between the resulting digitized text from each unique optical character recognition operation.

According to a third embodiment of the invention, there is provided a method of obtaining and assigning a confidence level to computer-generated text comprising the steps of: (a) providing a scanning device for scanning at least one container having a medical label including medical information, the medical label including graphical text, the scanning device configured to obtain image data from the medical label, and the scanning device including: (i) a housing having a receptacle for receiving the container, the receptacle having a floor and an interior sidewall, the interior sidewall including a plurality of lights for illuminating the container; (ii) a rotatable turntable positioned on the floor of the receptacle and the container being positionable on the turntable; and (iii) at least one camera located within the housing and positioned so that the camera can obtain images of the medical label, the camera being configured to obtain still images of various angles of the medical label as the container is rotated on the turntable; (b) providing a computer having software that is configured to generate digitized computer-readable text from graphical text in an image file; (c) transmitting the image data from the scanning device to the computer; (d) creating digitized text of the graphical text, by the computer software, the step of creating digitized text including the application of at least two optical character recognition operations; and (e) assigning a confidence level for the digitized text based upon the consistency or variation of the digitized text created by each optical character recognition operation.

Optionally this method can include the step of assigning a minimum threshold level for the assigned confidence levels, and further including the step of manually verifying, by a user, that the digitized text was correctly generated from the image data for the portions of the digitized text in which the confidence level is below the minimum threshold level.

Optionally this method can include providing a database of known similarly-named items of the medical information, and further including the step of manually verifying, by a user, or any digitized text matching one of the similarly-named items in the database.

Optionally this method can include in which the similarly-named items in the database are selected from the group consisting of: a drug name, a drug dosage, a dosage form, a prescription quantity, and a drug name suffix.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a first perspective view showing the scanning device and a computer;

FIG. 2 is a second perspective view of the scanning device;

FIG. 3 is a screenshot view of a computer operating software interfacing with the scanning device as the prescription label is being scanned;

FIG. 4 is a user-interface of the software showing a screen where the agent's name and the patient's name are manually entered; and

FIG. 5 is a user-interface of the software showing various prescription drug health care plans listed with exemplary costs assigned dependent upon the prescription containers that were scanned.

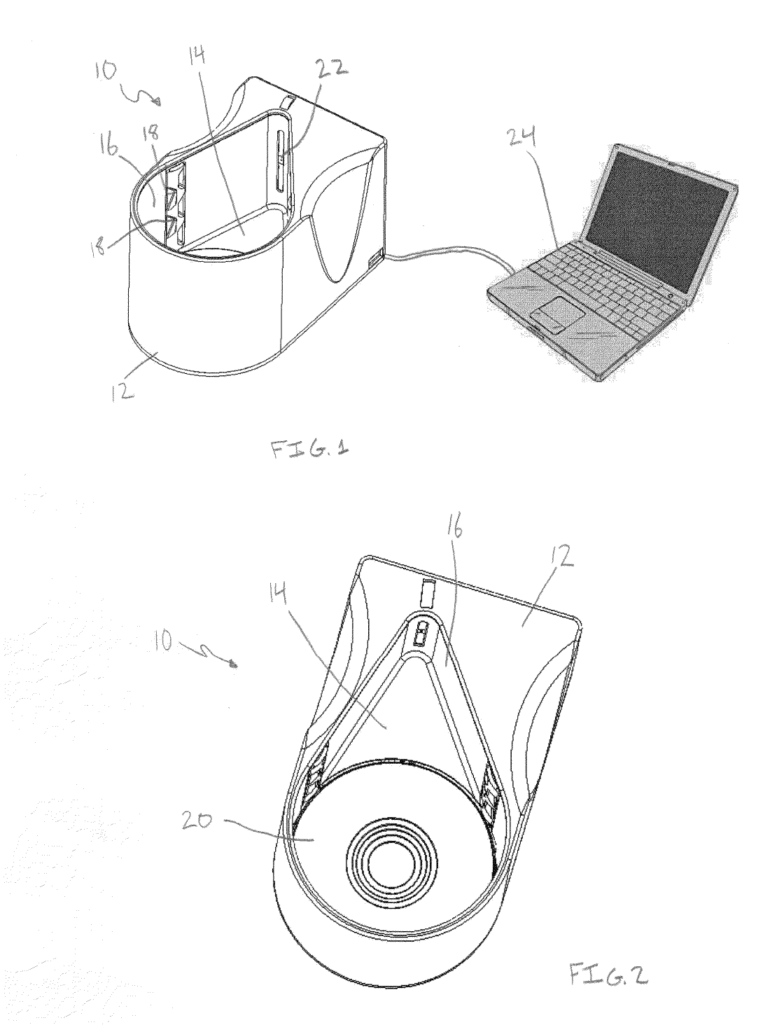

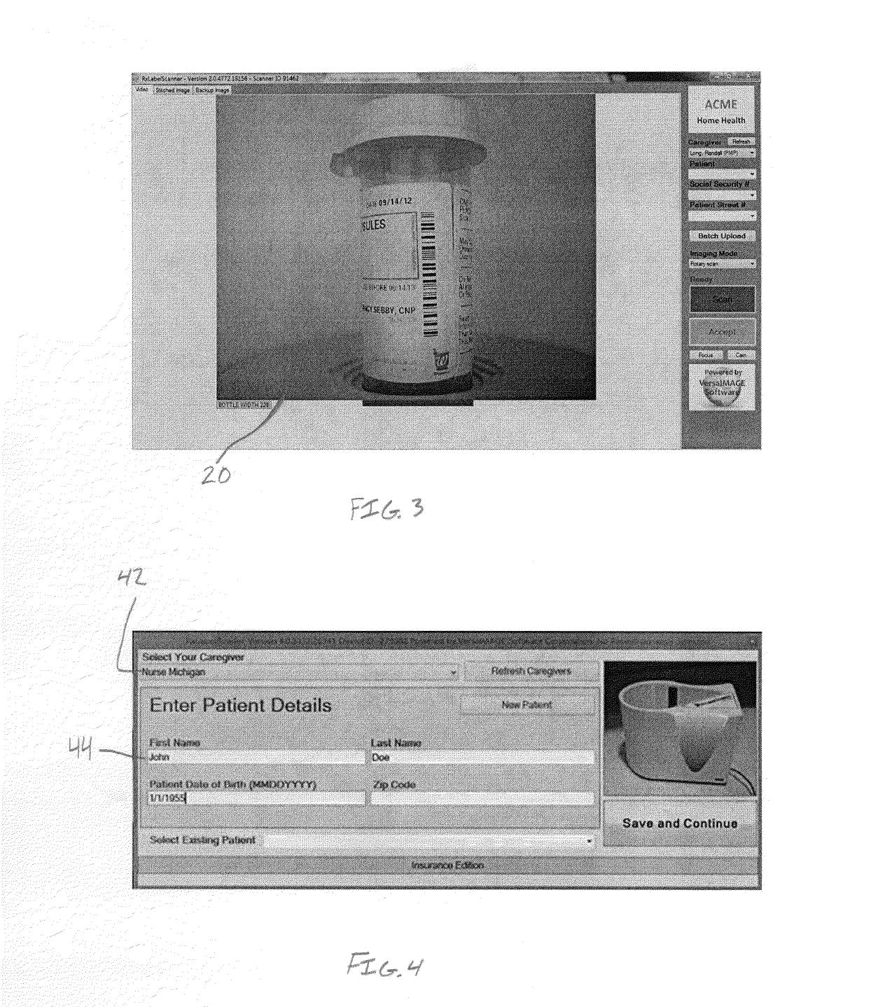

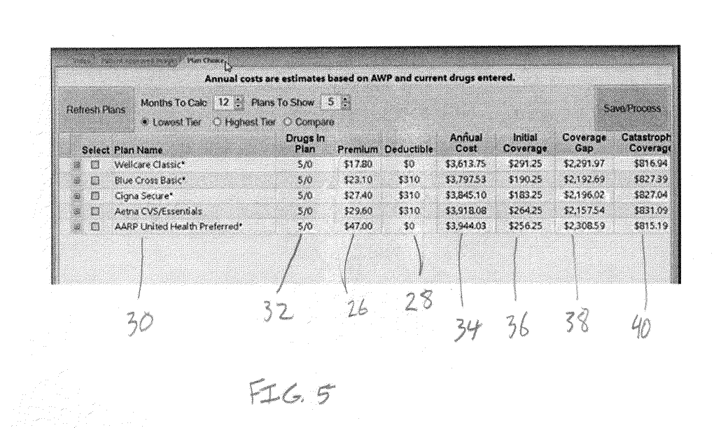

### DETAILED DESCRIPTION OF THE PREFERRED EMBODIMENT

At the outset of this detailed description, it bears mentioning that this invention builds upon the applicant's inventions disclosed in U.S. Pat. No. 8,823,770 and U.S. Patent Application Publication Nos. 2014/0281871 and 2014/0354769, the disclosures of which are hereby incorporated by reference. As such, the scanning device 10 and the methods of identifying and digitizing the prescription label contents will not be discussed in great detail below because they are disclosed thoroughly in these other documents incorporated by reference.

In accordance with a first embodiment of the present invention there is provided a method of compiling and ranking health insurance plans for a patient which includes the use of a scanning device 10 for scanning at least one prescription container including medical information. The scanning device 10 is configured to obtain image data from the prescription containers that are placed into the device's housing 12 by a user.

The medical information contained on the prescription container label can include the drug's name, dosage, dosage form, prescription quantity, prescription notes, drug name suffix, and so forth.

The scanning device 10 includes a housing 12 having a receptacle for receiving the prescription container and a floor 14 and an interior sidewall 16. The interior sidewall 16 includes a plurality of lights 18 for illuminating the prescription container. There is also a rotatable turntable 20 positioned on the floor 14 of the receptacle, and the prescription container can be placed on the turntable 20. At least one camera 22 is located within the housing 12 and positioned so that the camera 22 can obtain images of the prescription container. The prescription container rotates on the turntable 20 while the camera 22 obtains still images of various angles of the prescription container.

A computer 24 is also provided which has software configured to create digitized text from text characters in the image of the prescription container. The details by which this is accomplished are discussed in the applicant's other disclosures which have been incorporated by reference above. The scanning device 10 transmits the image data to the computer 24 using any suitable mechanism for transmission, such as a USB cord, a network cord, or other suitable hard-wired connection. Alternatively the image data can be sent to the computer 24 from the scanning device 10 wirelessly by using a wireless network, Bluetooth® technology, or the like.

The computer 24 has software configured to create a two-dimensional image of the prescription container using the image data. The software then creates the digitized text of the medical information from the two-dimensional image using any suitable type of optical character recognition (OCR) methods, as well as those OCR methods described in the applicant's other disclosures that have been incorporated by reference.

Optionally, the step of creating digitized text can include the use of multiple OCR operations, each of which is different from the other. When multiple OCR operations are used, a confidence level may be assigned to portions of the digitized text based upon the consistency of the results from the multiple OCR operations. This can also include the step of assigning a minimum threshold level for the assigned confidence levels. And when a minimum threshold is not met, the software can require manual verification by a user that the digitized text was correctly generated for that digitized text which was flagged.

The OCR operation(s) can be used in conjunction with different filters intended to filter out different specific background noise on the image. For example, different color filters or contrast settings can be applied to drown out unintended markings that might interfere with the OCR process.

Furthermore, a database is provided which includes a plurality of health insurance plans. The health insurance plans could be Medicare Part D prescription drug plans, Medicare Advantage Plans, or any other type of health insurance plans, regardless of whether the plans are associated with a U.S. government plan or a list of entirely private plans. Each health insurance plan has a number of parameters, or information, associated with it, such as any of the following: a monthly premium, a deductible, the names of the drugs covered by the respective plan, the tier(s) assigned to each drug in the plan, the average wholesale price (AWP) of the drugs in the plan, and the various costs associated with each drug in the plan based upon the drug's dosage, quantity, or dosage form.

In addition, the availability and cost of various health insurance plans can vary from state-to-state, county-to-county, or possibly even zip code-to-zip code. Thus, location is a separate factor which will impact the availability and cost of the health insurance plans. Accordingly, each state, county, or even zip code could have its own unique database of health insurance plans.

Next, an annual cost to the patient is calculated by the computer 24 using the parameters identified above for each plan in the database. A list is created including at least two of the health insurance plans in the database. The list displays a number of identifiers for each plan, including but not limited to, the prescription drug health care plan 30, how many of the patient's drugs are covered by that plan 32, the monthly premium for that plan 26, the deductible 28, the annual cost to the patient 34, the initial coverage 36, the coverage gap 38, and the catastrophic coverage 40. The list is sortable by any of these identifiers, but preferably it is first sorted by the number of drugs in the plan, and then by annual cost to the patient. Alternatively, the list can be sorted strictly by annual cost to the patient. Thus, a list is produced which ranks prescription drug health insurance plans based on annual cost to the patient.

Each plan in the list does not necessarily provide coverage for each of the patient's drugs. In that case, the full out-of-pocket expense to the patient for those excluded drugs will be added to the cost under the plan for those included drugs.

It is also noted that a second list of drugs may be provided which lists any drugs that are not included in any of the health insurance plans in the database so that the patient is aware that those drugs are not eligible for any of the health insurance plans.

According to a second embodiment of the invention, there is provided a method of generating a photographic inventory of a patient's prescription containers including the steps of: (a) providing the scanning device 10 described above; (b) providing a computer 24 having software that provides for entry of a name of an operator 42; (c) transmitting the image data from the scanning device 10 to the computer 24; and (d) providing a database and storing information in the database that is accessible by the computer 24, the database including the following information associated with each prescription container: a two-dimensional image of each prescription container that is generated using the image data, the name of the operator (or agent) responsible for cataloging each of the patient's drugs and entering them for consideration in selecting a prescription drug health care plan, and a name of the patient 44.

In this manner, the invention provides reproducible evidence of the agent's name, the patient's name, and photographic proof of each drug that was scanned by the device and entered into the system for evaluation of cost by each drug plan in the database.

A third embodiment of the invention is provided which is directed to a method of obtaining and assigning a confidence level to computer-generated text comprising the steps of: (a) providing the scanning device 10 described above; (b) providing a computer 24 having software that is configured to generate digitized computer-readable text from graphical text in an image file; (c) transmitting the image data from the scanning device 10 to the computer 24; (d) creating digitized text of the graphical text using at least two OCR operations; and (e) assigning a confidence level to the digitized text based upon the consistency or variation of the digitized text created by each OCR operation.

This can additionally include the step of assigning a minimum threshold level for the assigned confidence levels. When text is identified as having a confidence level below the minimum threshold level, then the software can prompt the user to manually verify that the digitized text was correctly generated from the image data.

A database of known similarly-named items may be provided as well. Any time that digitized text is generated for the medical information which matches any of the medical information in this database, the software can prompt the user to manually verify that the digitized text was correctly generated from the image data and not the other similarly-named item. The similarly-named items in the database can include a drug name, a drug dosage, a dosage form, a prescription quantity, a drug name suffix, and so forth.

As is apparent from the preceding, the present invention provides a method for automatically obtaining the information off of each of the patient's prescription labels, extracting the data into a digital format, entering the data into a database including prescription drug health care plans, and generating a sortable list of healthcare plans based upon out-of-pocket costs to the patient.

What is claimed is:

1. A method of compiling and ranking health insurance plans for a patient including the steps of:
providing a scanning device for scanning at least one prescription container including medical information, the scanning device configured to obtain image data from the prescription container;
providing a computer having software that is configured to create digitized text from text characters in an image of the prescription container;
transmitting the image data from the scanning device to the computer;
creating a two-dimensional image of at least a portion of the prescription container using the image data;
creating digitized text, by the software, of the medical information on the two-dimensional image, the medical information including at least a drug name;
providing a database including a plurality of health insurance plans;
calculating a cost to the patient using the medical information and information contained in the database of health insurance plans; and
creating a list of at least two of the health insurance plans including the calculated cost to the patient for each of the listed health insurance plans, and the list being sortable by cost to the patient in order to rank the health insurance plans.

2. The method of claim 1 in which the medical information includes at least one of the following from the group consisting of: a drug dosage, a dosage form, a prescription quantity, prescription notes, and a drug name suffix.

3. The method of claim 2 in which the step of creating digitized text includes the use of an optical character recognition operation.

4. The method of claim 3 in which the step of creating digitized text includes the use of a plurality of optical character recognition operations, and further includes the step of assigning a confidence level to portions of the digitized text based upon the consistency of the results from the plurality of optical character recognition operations.

5. The method of claim 4 including the step of assigning a minimum threshold level for the assigned confidence levels, and further including the step of manually verifying, by a user, that the digitized text was correctly generated from the image data for the portions of the digitized text in which the confidence level is below the minimum threshold level.

6. The method of claim 3 including the step of applying at least two filters to the image to filter specific background noise on the image.

7. The method of claim 1 in which the medical information includes a drug dosage, a dosage form, a prescription quantity, prescription notes, and a drug name suffix.

8. The method of claim 7 in which the step of creating digitized text includes the use of an optical character recognition operation.

9. The method of claim 8 in which the step of creating digitized text includes the use of a plurality of optical character recognition operations, and further includes the step of assigning a confidence level to portions of the digitized text based upon the consistency of the results from the plurality of optical character recognition operations.

10. The method of claim 9 including the step of assigning a minimum threshold level for the assigned confidence levels, and further including the step of manually verifying, by a user, that the digitized text was correctly generated from the image data for the portions of the digitized text in which the confidence level is below the minimum threshold level.

11. The method of claim 8 including the step of applying at least two filters to the image to filter specific background noise on the image.

12. The method of claim 1 in which the step of creating digitized text includes the use of an optical character recognition operation.

13. The method of claim 12 in which the step of creating digitized text includes the use of a plurality of optical character recognition operations, and further includes the step of assigning a confidence level to portions of the digitized text based upon the consistency of the results from the plurality of optical character recognition operations.

14. The method of claim 13 including the step of assigning a minimum threshold level for the assigned confidence levels, and further including the step of manually verifying, by a user, that the digitized text was correctly generated from the image data for the portions of the digitized text in which the confidence level is below the minimum threshold level.

15. The method of claim 12 including the step of assigning a minimum threshold level for the assigned confidence levels, and further including the step of manually verifying, by a user, that the digitized text was correctly generated from the image data for the portions of the digitized text in which the confidence level is below the minimum threshold level.

16. A method of generating a photographic inventory of a patient's prescription containers comprising the steps of:
providing a scanning device for scanning at least one prescription container including medical information, the scanning device configured to obtain image data from the prescription container, and the scanning device including:
a housing having a receptacle for receiving the prescription container, the receptacle having a floor and an interior sidewall, the interior sidewall including a plurality of lights for illuminating the prescription container;
a rotatable turntable positioned on the floor of the receptacle and the prescription container being positionable on the turntable; and
at least one camera located within the housing and positioned so that the camera can obtain images of the prescription container, the camera being configured to obtain still images of various angles of the prescription container as the prescription container is rotated on the turntable;
providing a computer having software that provides for entry of a name of an operator;
transmitting the image data from the scanning device to the computer;
providing a database and storing information in the database that is accessible by the computer, the database including the following information associated with each prescription container: a two-dimensional image of each prescription container that is generated using the image data, the name of an operator operating the scanning device, and a name of the patient.

17. The method of claim 16 including the step of manually entering the name of the operator by typing the name into the computer.

18. The method of claim 16 including the step of manually entering the name of the patient by typing the name into the computer.

19. The method of claim 16 including the step of performing optical character recognition, by the software, on the two-dimensional image of each of the prescription containers.

20. The method of claim 19 in which performing the optical character recognition generates digitized text, and the digitized text includes any of the following from the group of medical information: a drug name, a drug dosage, a dosage form, a prescription quantity, prescription notes, and a drug name suffix.

21. The method of claim 19 in which performing the optical character recognition generates digitized text, and the digitized text includes the following medical information: a drug name, a drug dosage, a dosage form, a prescription quantity, prescription notes, and a drug name suffix.

22. The method of claim 19 in which the software performs at least two optical character recognition operations, and each optical character recognition operation utilizes a unique set of parameters for determining each character of the digitized text.

23. The method of claim 22 including the step of assigning a confidence level to portions of the digitized text, the confidence level being determined by the consistency or variation between the resulting digitized text from each unique optical character recognition operation.

24. The method of claim 16 in which the software performs at least two optical character recognition operations, and each optical character recognition operation utilizes a unique set of parameters for determining each character of the digitized text.

25. The method of claim 24 including the step of assigning a confidence level to portions of the digitized text, the confidence level being determined by the consistency or variation between the resulting digitized text from each unique optical character recognition operation.

26. The method of claim 19 including the step of applying at least two filters to the image to filter specific background noise on the image.

27. The method of claim 24 including the step of applying at least two filters to the image to filter specific background noise on the image.

28. A method of obtaining and assigning a confidence level to computer-generated text comprising the steps of:
providing a scanning device for scanning at least one container having a medical label including medical information, the medical label including graphical text, the scanning device configured to obtain image data from the medical label, and the scanning device including:
a housing having a receptacle for receiving the container, the receptacle having a floor and an interior sidewall, the interior sidewall including a plurality of lights for illuminating the container;
a rotatable turntable positioned on the floor of the receptacle and the container being positionable on the turntable; and
at least one camera located within the housing and positioned so that the camera can obtain images of the medical label, the camera being configured to obtain still images of various angles of the medical label as the container is rotated on the turntable;
providing a computer having software that is configured to generate digitized computer-readable text from graphical text in an image file;
transmitting the image data from the scanning device to the computer;
creating digitized text of the graphical text, by the computer software, the step of creating digitized text including the application of at least two optical character recognition operations; and
assigning a confidence level for the digitized text based upon the consistency or variation of the digitized text created by each optical character recognition operation.

29. The method of claim 28 including the step of assigning a minimum threshold level for the assigned confidence levels, and further including the step of manually verifying, by a user, that the digitized text was correctly generated from the image data for the portions of the digitized text in which the confidence level is below the minimum threshold level.

30. The method of claim 28 including providing a database of known similarly-named items of the medical information, and further including the step of manually verifying, by a user, or any digitized text matching one of the similarly-named items in the database.

31. The method of claim 28 in which the similarly-named items in the database are selected from the group consisting of: a drug name, a drug dosage, a dosage form, a prescription quantity, and a drug name suffix.

32. The method of claim 26 including the step of applying at least two filters to the image to filter specific background noise on the image.
